(19) United States
(12) Patent Application Publication
(10) Pub. No.: US 2012/0207966 A1
(43) Pub. Date: Aug. 16, 2012

(54) BALLISTIC LAMINATE STRUCTURE

(75) Inventor: Lawrence J. Dickson, Granville, OH (US)

(73) Assignee: TENCATE ADVANCED ARMOR USA, INC., Newark, OH (US)

(21) Appl. No.: 13/456,927

(22) Filed: Apr. 26, 2012

Related U.S. Application Data
(62) Division of application No. 11/460,457, filed on Jul. 27, 2006.
(60) Provisional application No. 60/703,907, filed on Jul. 29, 2005.

(51) Int. Cl. F41H 5/04; B32B 7/12; B32B 5/26

(52) U.S. Cl. 428/110; 428/113; 428/221; 428/109; 428/114; 428/212; 89/36.02; 89/916

(57) ABSTRACT

A ballistic structure having at least one laminate sheet of a plurality of fiber bundles or tapes is disclosed. In embodiments having more than one laminate sheet, the inter-laminate shear strength between the laminate sheets is controlled to control ballistic effectiveness of the ballistic structure.

### CROSS REFERENCE TO RELATED APPLICATION

This application is a divisional of prior U.S. application Ser. No. 11/460,457, filed Jul. 27, 2006, titled BALLISTIC LAMINATE STRUCTURE, which application is hereby incorporated by reference in its entirety, and which claims priority to and any other benefit of U.S. Provisional Appln. No. 60/703,907 filed Jul. 29, 2005, titled BALLISTIC LAMINATE STRUCTURE WITH ADHESIVE WET OUT, which application is hereby incorporated by reference in its entirety.

### BACKGROUND

Laminate sheets incorporating fibers may be used in soft body armor, as backing for a ceramic facing in hard armor, in hard armor panels, or in other ballistic applications. Such laminate sheets have varied ballistic performance depending on how the laminate sheets are formed and on the materials used to form the laminate sheets. These laminate sheets may suffer from inadequate ballistic performance or from excessive weight for a particular application. Thus, there remains a need in the art for additional laminate sheets and methods of making laminate sheets.

### SUMMARY OF THE INVENTION

In accordance with some embodiments, laminate sheets for use in a ballistic structure are provided. The laminate sheets can comprise a first layer of fiber bundles having an adhesive layer or a release layer; at least a second layer of fiber bundles and laminated to the first layer and oriented at an angle between 0 and 180 degrees relative to the first layer to form a laminate sheet; and at least one additional adhesive or release layer. The at least one of the first layer or second layer has an adhesive layer or release layer penetrating the fiber bundles. The laminate sheet has at least one adhesive layer or release layer adjacent to another adhesive layer or release layer. At least one of the adjacent adhesive or release layers are chosen to control the inter-laminar shear properties between at least one of the adjacent layers in the laminate sheet. In some embodiments, ballistic structures utilizing the laminate sheets are also provided.

In other embodiments, laminate sheets for use in ballistic structures are provided. The laminate sheets can comprise a first layer of tapes having an adhesive layer or a release layer; at least a second layer of tapes laminated to the first layer and oriented at an angle between 0 and 180 degrees relative to the first layer to form a laminate sheet; and at least an additional adhesive or release layer. The laminate sheet has at least one adhesive layer or release layer adjacent to another adhesive layer or release layer. At least one of the adjacent adhesive or release layers are chosen to control the inter-laminar shear properties between at least one of the adjacent layers in the laminate sheet. In other embodiments, ballistic structures comprising the laminate sheets are provided.

In accordance with further embodiments, laminate sheets are provided. The laminate sheets can comprise least one layer of unidirectionally-oriented fiber bundles bound together with an adhesive having a tensile modulus at 23° C. between about 7,000 psi and about 80,000 psi, wherein the adhesive penetrates the fiber bundles to form a matrix around at least one individual fiber in the fiber bundle and the adhesive comprises no more than about 30% by weight of the total laminate. In some embodiments, ballistic structures comprising the laminate sheets are provided.

In yet further embodiments, methods of making laminate sheets are provided. The methods can comprise positioning a layer of fiber bundles or tapes; applying an adhesive or a release layer to a surface of the layer of fiber bundles or tapes; and applying pressure to the fiber bundles or tape and the adhesive or release layer to laminate the fiber bundles or tapes such that a laminate sheet is formed.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify the embodiments of this invention.

FIG. 1 is a representational view of a layer of fiber bundles with an adhesive layer;

FIG. 2 is a representational view of a layer of fiber bundles with the adhesive layer present on the top and the bottom;

FIG. 3 is a representational view of two layers of fiber bundles, each layer with an adhesive layer;

FIG. 4 is a representational view of a layer of fiber bundles with an adhesive layer and a release layer;

FIG. 5 is a representational view of two layers of fiber bundles with an adhesive layer and release layers;

FIG. 6 is a representational view of two layers of fiber bundles and release layers;

FIG. 7 is a representational view of another embodiment of two layers of fiber bundles and release layers; and

FIG. 8 is a representational view of another embodiment of two layers of fiber bundles and release layers.

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

The present invention is directed to a ballistic material suitable for use in armor applications, particularly lightweight armor applications. The material is suitable for use in, among other uses, hard armor panels, for use behind ceramic materials as a backing, and as a soft armor material for body armor.

In accordance with embodiments of the present invention, basic laminates are provided. In one example, the basic laminate comprises a layer of fiber bundles with an adhesive layer disposed adjacent to the fiber bundle layer. In another example, the basic laminate comprises a layer of fiber bundles with a release layer disposed adjacent to the fiber bundle layer. In a further example, the basic laminate comprises a layer of tapes with an adhesive layer disposed adjacent to the tape layer. In yet a further example, the basic laminate comprise a layer of tapes with a release layer disposed adjacent to the tape layer.

When the basic laminate comprises a fiber bundle layer and an adhesive layer, the adhesive is applied to the surface of the fiber bundles. Any suitable adhesive may be used as will be discussed further herein, and the adhesive may be in any suitable form. For example, the adhesive may be in the form of a discontinuous resin layer, wet resin layer, film layer, powder layer, or hot melt applied layer The adhesive adheres the fiber bundles into an array or layer. Once the adhesive is applied to the fiber bundle layer, the adhesive layer is then forced under heat and pressure to penetrate into the fiber bundles. An adhesive matrix forms which may encapsulate a substantial number of fibers in each fiber bundle.

The adhesive forms a continuous or discontinuous matrix around the fibers in the fiber bundles. The adhesive may comprise any suitable amount by weight of the basic laminate. In some examples, the adhesive layer is no more than about 30% by weight of the basic laminate. In other examples, the adhesive is less than about 10% by weight of the basic laminate. In yet further examples, the adhesive is less than about 5% by weight of the basic laminate. The adhesive may be applied in any suitable manner, including, but not limited to, application in powder faun with subsequent fusing to the fiber bundle layer, randomly dispersed continuous or chopped filaments head fused to the fiber bundle layer, or application of a non-woven array of thermoplastic adhesive, such as a hot-melt adhesive web, for example, that sold under the trademark Spunfab®, sold by Spunfab Corporation, Cuyahoga Falls, Ohio. The adhesive layer may or may not act as the sole adhesion layer for the fiber bundle layer. It will be understood that once heat and pressure is applied to the basic laminate, the adhesive layer tends to wet out the fiber network in the fiber bundle layer.

Use of the term “wet out” indicates penetration of the material into the fiber bundle. The material flows around individual fibers in the fiber bundle instead of resting on the surface of the fiber bundle. The penetration of the material into the fiber bundle may be substantially complete, in which at least about 90% of the fibers in a fiber bundle are contacted by the material, or a majority of the fibers in a fiber bundle are contacted by the material, or as few as about 10% or about 1% of the fibers in the fiber bundle are contacted by the material. The extent of the wet out is influenced by the specific material, the particular fiber, and the pressure and temperature applied to the fiber bundle after application of the material.

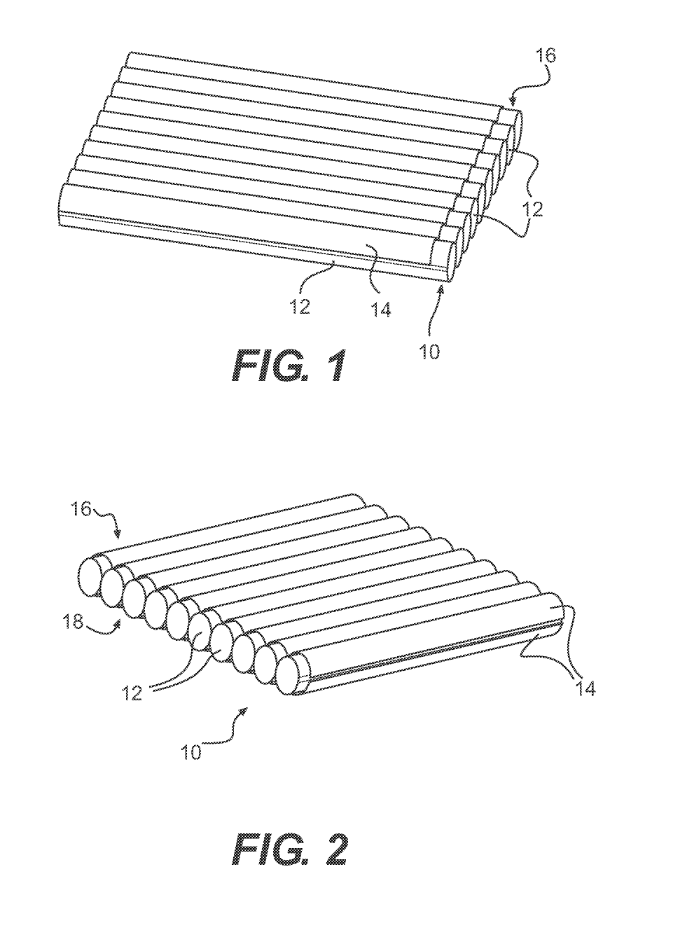

FIG. 1 illustrates a first fiber bundle layer 10 with a plurality of fiber bundles 12 arranged unidirectionally. An adhesive layer 14 is applied to the fiber bundles in a manner that causes it to wet out the filaments of the fiber bundles 12. The adhesive layer 14 is applied to one or more surfaces of the fiber bundles 12, and, as described in greater detail below, processed at a temperature and pressure to cause penetration of the adhesive layer 14 into the fiber bundles 12. The extent of the penetration is controlled by the pressure and temperature applied, based on the specific fiber and adhesive used and may be determined without undue experimentation. Even though adhesive penetrates into the fiber bundles, an adhesive layer 14 remains in the surface of the fiber bundles.

In one example, the adhesive penetrates substantially all of the fiber bundles 12. In another example, application and penetration of the adhesive results in an adhesive layer 14 present on both the top and the bottom surface of the fiber bundles 12, as illustrated in FIG. 2. The penetration of the adhesive may occur by placing an adhesive layer on one or both sides of the fiber bundle layer and forcing it to penetrate the surface of the fiber bundle layer using heat (to reduce viscosity, if needed) or pressure or both.

When an adhesive layer is used, the adhesive layer may be in the form of:
1. another spun adhesive web, film, chopped fiber array, continuous fiber array, or powder that is applied like the first material that does not wet out the fiber in a fiber bundle layer or the tapes in a tape layer;
2. another spun adhesive web, film, chopped fiber array, continuous fiber array or powder that is applied like the first material that does wet out at least one fiber and forms an adhesive matrix in a fiber bundle layer;
3. a wet resin adhesive that does not wet out the fiber in a fiber bundle layer or the tapes in a tape layer;
4. a wet resin adhesive that does wet out at least one fiber and forms a resin matrix in a fiber bundle layer;
5. a continuous or discontinuous adhesive film layer that does not wet out the fiber in a fiber bundle layer or the tapes in a tape layer;
6. a continuous or discontinuous adhesive film layer that partially contacts at least one fiber of a fiber bundle layer;
7. a hot melt thermoplastic adhesive applied to the fiber bundle layer or to the tape layer; or
8. a combination of the above.

When the basic laminate comprises a fiber bundle layer and a release layer, the release layer is applied to the surface of the fiber bundles. Any suitable release layer may be used, and the release layer may be in any suitable form. For example, suitable materials include paper, metal foil, plastic film, and silicone based release layers or coatings. The release layer may be a continuous, discontinuous, or perforated layer. Once the release layer is applied to the fiber bundle layer, the release layer and fiber bundle layer is laminated. In some instances, certain release layers may be forced under heat and pressure to penetrate into the fiber bundles. In this instance, a release layer may encapsulate a substantial number of fibers in the fiber bundles. It will be understood that once heat and pressure is applied to the basic laminate, the certain release layers tend to wet out the fiber network in the fiber bundle layer.

The release layer may comprise any suitable amount by weight of the basic laminate. In some examples, the release layer is no more than about 30% by weight of the basic laminate. In other examples, the release layer is less than about 10% by weight of the basic laminate. In yet further examples, the release layer is less than about 5% by weight of the basic laminate.

In one example when a release layer is chosen that may wet out the fiber network in the fiber bundles layer, application and penetration of the release layer may result in a release layer present on both the top and the bottom surface of the fiber bundles in the fiber bundle layer. The penetration of the release layer may occur by placing a release layer on one or both sides of the fiber bundle layer and forcing it to penetrate the surface of the fiber bundle layer using heat (to reduce viscosity, if needed) or pressure or both.

The “release” characteristics of the release layer come from the fact that it provides a lower inter-laminar shear between an adjacent layer of a basic laminate than if it was not present. This is the case whether the release layer is part of the basic laminate or a control layer as further described herein. If it was not present, basic laminate layers having adhesive layers could stick to each other and provide a higher inter-laminar shear and a lower ballistic result. This is a surprising result, because conventional teaching is that the addition of release materials are parasitic and adversely affect the ballistic properties. The fact that the ballistic properties can be improved even though this parasitic weight is added is surprising. This release layer is generally chosen to exhibit poor bonding to adjacent layers as will be discussed further herein.

When a release layer is used, the release layer may be in the form of:
1. a wet coating or release layer that does not wet out the fiber in a fiber bundle layer;
2. a wet coating or release layer that does wet out at least one fiber in a fiber bundle layer and forms a matrix;
3. a continuous or discontinuous film layer that does not wet out the fiber in a fiber bundle layer;
4. a continuous or discontinuous film layer that partially contacts at least one fiber in a fiber bundle layer;
5. a wet coating or release layer that does not wet out the tapes in a tape layer;
6. a continuous or discontinuous film layer that does not wet out the tapes in a tape layer;
7. a continuous or discontinuous film layer that partially contacts at least one fiber in a fiber bundle layer; or
8. a combination of the above.

It will be understood that any suitable fiber bundles may be used, as will be discussed further herein. The manner in which the fiber bundles are dispersed may vary widely. The fiber bundles may be aligned in a substantially parallel, unidirectional fashion, or the fiber bundles may by aligned in a multidirectional fashion with fiber bundles at varying angles to each other. In some embodiments of this invention, fiber bundles in each layer are aligned in a substantially parallel, unidirectional fashion such as in a pre-preg, pultruded sheet and the like.

When the basic laminate comprises a tape layer having an adhesive layer adjacent thereto, the adhesive layer is applied to the surface of the tape layer. In this instance, the adhesive layer does not generally wet out the individual fibers making up the tapes in the tape layer. As discussed above, any suitable adhesive in any suitable form may be used. The adhesive may comprise any suitable amount by weight of the basic laminate. In some examples, the adhesive layer is no more than about 30% by weight of the basic laminate. In other examples, the adhesive is less than about 10% by weight of the basic laminate. In yet further examples, the adhesive is less than about 5% by weight of the basic laminate. The adhesive may be applied in any suitable manner as discussed above. The adhesive layer may or may not act as the sole adhesion layer for the tape layer.

When the basic laminate comprises a tape layer having a release layer adjacent thereto, the release layer is applied to the surface of the tape layer. In this instance, the release layer does not generally wet out the individual fibers making up the tapes in the tape layer. As discussed above, any suitable release layer in any suitable form may be used. The release layer may comprise any suitable amount by weight of the basic laminate. In some examples, the release layer is no more than about 30% by weight of the basic laminate. In other examples, the release layer is less than about 10% by weight of the basic laminate. In yet further examples, the release layer is less than about 5% by weight of the basic laminate.

It will be understood that any suitable tapes may be used to form the tape layer, as will be discussed further herein. It will also be understood that the manner in which the tapes are dispersed may also vary widely. The tape may be aligned in a substantially parallel, unidirectional fashion. Alternatively, the tape in the tape layer may be aligned in a multidirectional fashion with tapes at varying angles to each other.

It will be understood that the basic laminates described above can further include an additional adhesive or release layer. For example, the basic laminate may have a release layer on the top side of the laminate and an adhesive layer on the bottom side of the fiber bundle or tape layer. Alternatively, the basic laminate can have a release layer on the top and bottom side of the fiber bundle or tape layer. In another example, the basic laminate can have an adhesive layer on the top and bottom side of the fiber bundle or tape layer.

In embodiments of the present invention, the basic laminates discussed above can be combined to form complex laminates. The complex laminates comprise at least two layers of basic laminates. The basic laminates are chosen such that at least two of the adjacent laminates have an adhesive or release layer that interacts with a different, adjacent adhesive or release layer on the adjacent laminate to reduce or change inter-laminar sheer. Generally, the adjacent adhesive or release layers are chosen such that the inter-laminar sheer that results from the binding of the adjacent adhesive or release layers is changed versus what the inter-laminar sheer would be if the adjacent layers had the same adhesive or release layers. It is believed that control of the inter-laminar shear properties between the layers of the basic laminate can improve the effectiveness of the laminates as a ballistic material.

For example, one basic laminate could have an adhesive layer and the adjacent basic laminate could have a release layer. In this instance, the release layer is chosen to provide different bonding characteristics to the adjacent adhesive layer, and the release layer may or may not provide some bonding to the adhesive of the basic laminates. For example, the release layer on one basic laminate may be chosen to provide poor adhesion to an adjacent adhesive layer on a basic laminate. The bonding affinity or strength between the release layer and the adhesive may be reduced by at least about 15%, when measured by the climbing drum peel test performed in accordance with ASTM 1781-98, as compared to the adhesion of the adhesive bonded to itself.

In another example, one basic laminate could have a first release layer and the adjacent basic laminate could have a second release layer. The first and second release layers are chosen such that the inter-laminar sheer between the two basic layers is different from what the inter-laminar sheer would be if either the first or second release layer was bonded to a release layer of the same type. In this instance, the first release layer may or may not provide some bonding to the second release layer of the basic laminates.

In yet another example, one basic laminate could have a first adhesive layer and the adjacent basic laminate could have a second adhesive layer. For example, the first and second adhesive layers are chosen to provide different bonding characteristics when bonded to each other than the bonding characteristics of the first or second adhesives to themselves. In this instance, the different adhesives have poor bonding characteristics in relation to each other. So while there may be some bonding between the adjacent adhesive layers, the strength of this bonding is relatively weak. For example, the bonding affinity or strength between the first adhesive and the second adhesive is reduced by at least about 15%, when measured by the climbing drum peel test performed in accordance with ASTM 1781-98, as compared to the adhesion of either adhesive bonded to itself. Again, this facilitates inter-laminar de-bonding during ballistic impact at the site of the ballistic impact.

In some examples, at least one of the basic laminates in the complex laminates comprise a basic laminate having a fiber bundle layer and adhesive or release layer that at least partially wets out fibers in the fiber bundle layer. In other examples, at least one of the basic laminates in the complex laminates comprise a basic laminate having a tape layer.

The complex laminates can be formed in any suitable manner. For example, a combination of heat and pressure may be applied to two or more basic laminates to form a complex laminate. In some examples, the complex laminate may be a combination of a suitable number of basic laminates stacked and laminated in such a way as to retain flexibility. In other examples, the flexible complex laminates can be further stacked, layered, or combined to provide a more rigid laminate, such as, for example, a thick, rigid armor product.

In yet further embodiments, complex laminates having one or more control layers disposed between adjacent basic laminate layers are provided. As will be discussed further herein, the control layer is chosen such that the binding properties between adjacent laminate layers are changed by the introduction of the control layer. The control layer is chosen such that there is lower inter-laminar sheer between the adjacent basic laminate layers than there would be in the absence of the control layer. It is believed that control of the inter-laminar shear properties between the layers of the basic laminate can improve the effectiveness of the laminates as a ballistic material. The control layer is at least one additional adhesive layer or additional release layer disposed between adjacent basic laminates.

When the control layer comprises at least one additional release layer, the release layer is provided between adjacent layers of basic laminates. Any suitable release layer as the control layer may be used depending on the basic laminates chosen. For example, the release layer as the control layer is chosen to provide different bonding characteristics to an adjacent adhesive layer when at least one of the adjacent basic laminates is a fiber bundle or tape layer having an adhesive layer. In this instance, the release layer as the control layer may or may not provide some bonding to the adhesive of the basic laminates. For example, the release layer as the control layer may be chosen to provide poor adhesion to an adjacent adhesive layer on a basic laminate. The bonding affinity or strength between the release layer as the control layer and the adhesive may be reduced by at least about 15%, when measured by the climbing drum peel test performed in accordance with ASTM 1781-98, as compared to the adhesion of the adhesive bonded to itself.

In another example, the release layer is chosen to provide different bonding characteristics to an adjacent release layer when at least one of the adjacent basic laminates is a fiber bundle or tape layer having a release layer. In this instance, the release layer as the control layer may or may not provide some bonding to the release layer of the basic laminate. In general, the release layer as the control layer provides for a lower inter-laminar shear strength between the basic laminate layers to facilitate inter-laminar de-bonding at the point of impact of a ballistic event.

It will be understood that when the control layer is chosen to be a release layer, more than one release layer as the control layer may be provided between adjacent basic laminates. Additionally, more than one type of release layer as the control layer may be used between adjacent basic laminates.

When a release layer is used as the control layer, the control layer applied to the structure may be in the form of:
1. a wet coating or release layer that does not wet out the fiber in a fiber bundle layer;
2. a wet coating or release layer that does wet out at least one fiber in a fiber bundle layer and forms a matrix;
3. a continuous or discontinuous film layer that does not wet out the fiber in a fiber bundle layer;
4. a continuous or discontinuous film layer that partially contacts at least one fiber in a fiber bundle layer;
5. a wet coating or release layer that does not wet out the tapes in a tape layer;
6. a continuous or discontinuous film layer that does not wet out the tapes in a tape layer;
7. a continuous or discontinuous film layer that partially contacts at least one fiber in a fiber bundle layer; or
8. a combination of the above.

When the control layer comprises at least one additional adhesive layer, the adhesive layer is disposed between adjacent ballistic laminates. Any suitable adhesive layer as the control layer may be used depending on the basic laminates chosen. For example, the adhesive layer as the control layer is chosen to provide different bonding characteristics to an adjacent adhesive layer when at least one of the adjacent basic laminates is a fiber bundle or tape layer having an adhesive layer. In this instance, the different adhesives have poor bonding characteristics in relation to each other. So while there is some bonding between the adjacent adhesive layers, the strength of this bonding is relatively weak. For example, the bonding affinity or strength between the first adhesive as the control layer and the second adhesive of the basic laminate is reduced by at least about 15%, when measured by the climbing drum peel test performed in accordance with ASTM 1781-98, as compared to the adhesion of either adhesive bonded to itself. Again, this facilitates inter-laminar de-bonding during ballistic impact at the site of the ballistic impact. For example, the first basic laminate may have a first adhesive, and the second basic laminate may have a first adhesive and be adhered to the first basic laminate with a second adhesive as the control layer.

In another example, the adhesive layer is chosen to provide different bonding characteristics when at least one of the adjacent basic laminates is a fiber bundle or tape layer having a release layer. In this instance, the adhesive layer as the control layer may or may not provide some bonding to the release layer of the basic laminates. For example, the adhesive layer as the control layer may be chosen to provide poor adhesion to an adjacent release layer on a basic laminate.

It will be understood that when the control layer is chosen to be an adhesive, more than one layer of adhesive as control layers may be provided between adjacent basic laminates. Additionally, more than one type of adhesive as control layers may be used between adjacent basic laminates.

When an adhesive layer is used as the control layer, the control layer applied to the structure may be in the form of:
1. another spun adhesive web, film, chopped fiber array, continuous fiber array, or powder that is applied like the first material that does not wet out the fiber in a fiber bundle layer or the tapes in a tape layer;
2. another spun adhesive web, film, chopped fiber array, continuous fiber array or powder that is applied like the first material that does wet out at least one fiber and forms an adhesive matrix in a fiber bundle layer;
3. a wet resin adhesive that does not wet out the fiber in a fiber bundle layer or the tapes in a tape layer;
4. a wet resin adhesive that does wet out at least one fiber and forms a resin matrix in a fiber bundle layer;
5. a continuous or discontinuous adhesive film layer that does not wet out the fiber in a fiber bundle layer or the tapes in a tape layer;
6. a continuous or discontinuous adhesive film layer that partially contacts at least one fiber of a fiber bundle layer;
7. a hot melt thermoplastic adhesive applied to the fiber bundle layer or to the tape layer; or
8. a combination of the above.

It will be understood that any suitable combination of control layers and basic laminates may be chosen. For example, a complex laminate could comprise four layers of basic laminates with a one or more control layers disposed between any two sets of adjacent basic laminate layers. It will be understood that the positioning, type, and number of control layers may be chosen to obtain a desired ballistic result.

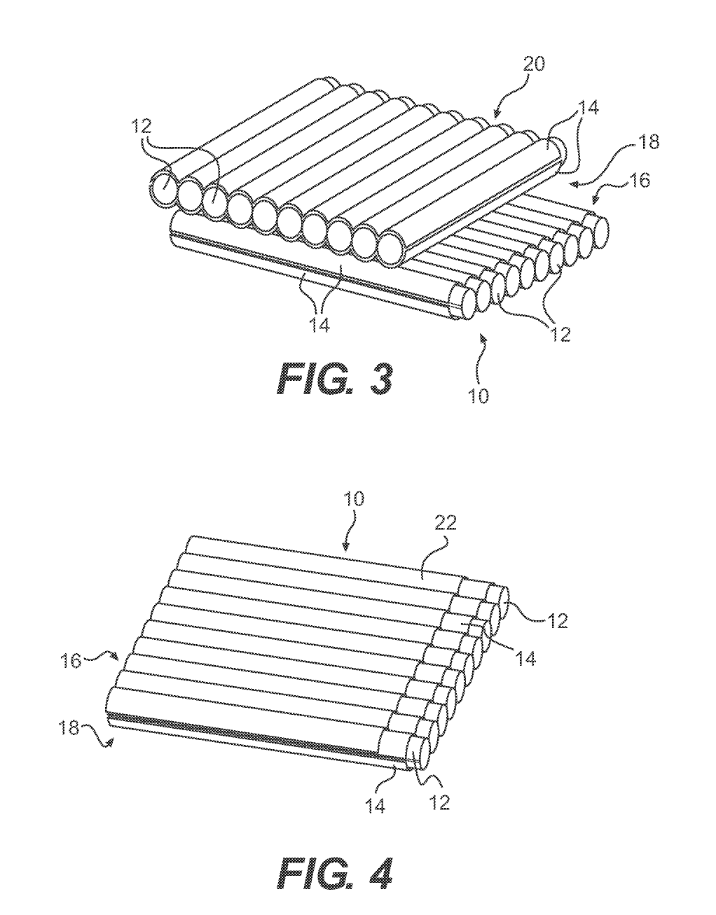

FIGS. 3-8 illustrate various configurations for basic and complex laminates with or without a control layer. It will be understood that these figures are merely illustrative of some of the combinations that may be provided. FIG. 3 illustrates a structure with the first fiber bundle layer 10 and a second fiber bundle layer 20 arranged perpendicularly to the first fiber bundle layer 10. In this embodiment, the adhesive layer 14 is a first adhesive applied to fiber bundles 12 of the first fiber bundle layer 10. This is a different adhesive than a second adhesive applied as adhesive layer 14 to the fiber bundles 12 of second fiber bundle layer 20. The first adhesive and the second adhesive both wet out the fibers or filaments of the fiber bundles 12, but have poor bonding properties relative to the other adhesive.

FIG. 4 illustrates the first fiber bundle layers 10 with adhesive layers 14 wetting out the network of filaments in fiber bundles 12. A release layer 22 which acts as a control layer is applied to the adhesive layer 14 on the top surface 16. The release layer 22 has poor adhesion to the adhesive layer 14, but does have limited adhesion to the adhesive layer 14.

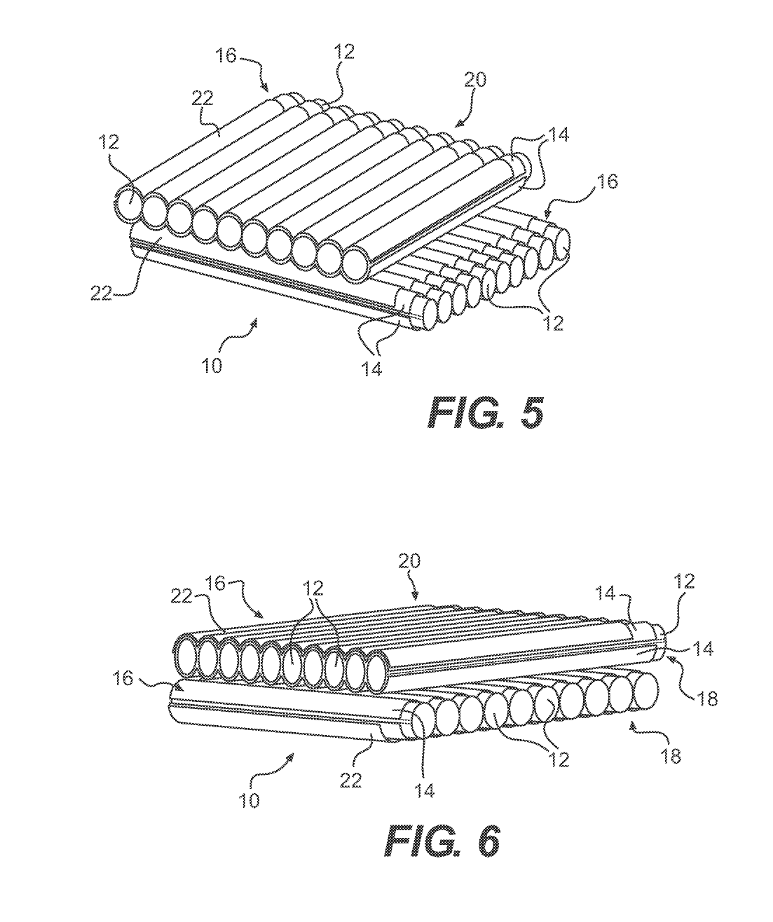

FIG. 5 illustrates a structure with first fiber bundle layer 10 and second fiber bundle layer 20. Both fiber bundle layers 10, 20 have an adhesive layer 14 applied in a manner to wet out the network of filaments in the fiber bundles 12, and the adhesive layers 14 applied to fiber bundle layers 10 may be the same as or different from each other. A release layer 22 which acts as the control layer is applied to the adhesive layer 14 on the top surface 16 of the first fiber bundle layer 10. The release layer 22 is between the first fiber bundle layer 10 and the second fiber bundle layer 20. Optionally, a release layer 22 is applied to the adhesive layer 14 on the top surface of the second fiber bundle layer 20, and release layer 22 may be the same as or different form the release layer 22 applied to the top surface 16 of the first fiber bundle layer 10.

FIG. 6 illustrates a structure with first fiber bundle layer 10 and second fiber bundle layer 20. Both fiber bundle layers 10, 20 have an adhesive layer 14 applied in a manner to wet out the network of filaments in the fiber bundles 12. A release layer 22 is applied to the adhesive layer 14 on the bottom surface 18 of the first fiber bundle layer 10 and a release layer 22 applied to the top surface 16 of the second fiber bundle layer 20, and the release layer 22 applied to the adhesive layer 14 on the bottom surface 18 of the first fiber bundle layer 10 may be the same as or different from the release layer 22 applied to the adhesive layer 14 on the top surface 16 of the second fiber bundle layer 20. The adhesive 14 on the top surface 16 of the first fiber bundle layer 10 and the bottom surface 18 of the second fiber bundle layer 20 are adhesives that both bond to the fiber substrates, but have poor bonding properties relative to the other adhesive.

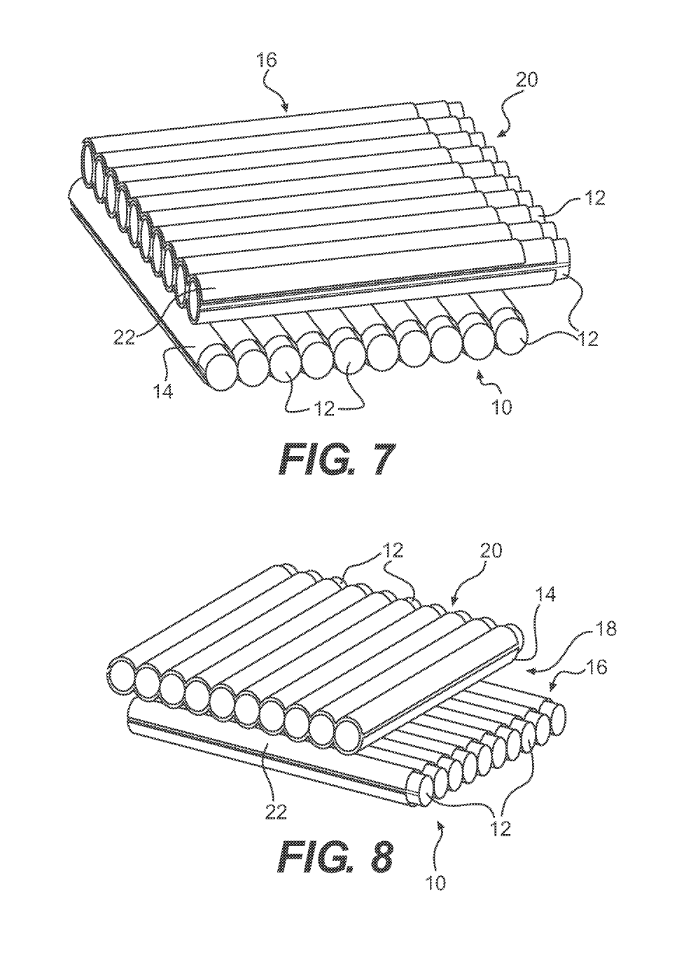

FIG. 7 illustrates a structure with first fiber bundle layer 10 and second fiber bundle layer 20. Both fiber bundle layers 10, 20 have an adhesive layer 14 applied in a manner to wet out the network of filaments in the fiber bundles 12. A release layer 22 is applied to the adhesive layer 14 on the top surface 16 of the second fiber bundle layer 20. The adhesive wetting out the first fiber bundle layer 10 and the adhesive wetting out the second fiber bundle layer 20 are different adhesives that both bond to the fiber substrates, but have poor bonding properties relative to the release layer.

FIG. 8 illustrates a structure with a first fiber bundle layer 10 and a second fiber bundle layer 20. The first fiber bundle layer 10 has a release layer 22 applied to the top surface 16 of the first fiber bundle layer 10. The release layer 22 may at least partially wet out the fibers in the first fiber bundle layer 10. The second fiber bundle layer 20 has an adhesive layer 14 applied to at least the bottom surface 18. The adhesive layer 14 may at least partially wet out the fibers in the second fiber bundle layer 20.

The Figures merely illustrate some of the combinations of basic laminates and control layers of the present invention. It will be understood that the fiber bundles illustrated can be replaced with tape layers in some or all of the layers. In these embodiments, the adhesive or release layers may not generally wet out the tape layers. Other combinations of fiber bundle layers, tape layers, adhesive, and release layers are also possible and contemplated without departing from the spirit and scope of the invention.

While some of the Figures illustrate structures having only two basic laminates, it is within the spirit and scope of the invention for more than two basic laminates to be provided in a single structure.

As illustrated in the Figures, the choice of basic laminate and control layers may be varied depending on the particular ballistic application encountered. For example, another layer added on top of second fiber bundle layer 20 in FIG. 7 could be provided with any suitable adhesive matrix, and the release layer 22 on the top surface 16 of the second fiber bundle layer would be disposed between the added fiber bundle layer and the second fiber bundle layer 20.

The arrangements and configurations of the adhesives and the release layers in adjacent basic laminates are chosen to have poor adhesion with the surface of the immediately adjacent basic laminate.

Complex laminates having more than one basic laminate layer and control layers may be formed with selective control layers between predetermined layers to accomplish the desired ballistic effectiveness. For example, in a complex laminate of four basic laminates, there may be a release layer as a control layer between the first and second basic laminate and between the third and fourth basic laminate, with no release layer as a control layer between the second and third basic laminate. Or there may be selected adhesives as control layers between the first and second basic laminate and no other release layer or adhesive chosen for poor adhesiveness with an adjacent layer in the remaining part of the complex laminate. It will be understood that two or more complex laminates can be formed and subsequently laminated together with or without the selection of a control layer between adjacent complex laminates.

The basic or complex laminates may also be provided with a protective film layer on the outside of the outer fiber or tape bundles to enhance durability, such as to resist moisture, wear, etc. The particular film used depends on the desired characteristics of the end product and its intended use, for example, a thin film of 0.5 mil urethane, 0.35 mil polyethylene, or an ultra thin film (less than 0.3 mil) mylar. It will be understood that any suitable film may be used.

In some embodiments, the basic laminates in a complex laminate can be oriented in any suitable manner. For example, the angles at which the first and second fiber bundle layers 10, 20 or tape layers are disposed relative to each other may be varied without departing from the spirit and scope of the invention. For example, the first and second fiber bundle layers or tape layers may be disposed at 45 degree angles relative to each other as opposed to the 90 degree angles illustrated in the Figures, or any other angle in between. In another example, first and second fiber bundle layers or tape layers may disposed at an angle between about 0 to about 180 degrees relative to each other.

Variety of the fiber or tape angles within a complex laminate is also within the spirit and scope of the invention. For example, a complex laminate may be made up of four layers with the second layer disposed at a 90 degree angle to the bottom layer, the third layer disposed at a +45 degree angle relative to the bottom layer and the top layer disposed at a −45 degree angle relative to the bottom layer. And one or more complex laminates may be disposed in a single article.

In many applications, a set of two layers disposed at 90 degree angles relative to each other (0, 90) is useful. For some applications, more than one laminate layer is used. Other variations include (0, 90, +45, −45)N, which represents N number of sets each set having four laminate layers disposed at the specified angles. It will be understood that any other suitable variations may be provided. For example, the complex laminate may have N layers disposed at (0, −45, +45, 90)N.

One such suitable arrangement is where a complex laminate includes a plurality of layers or laminates in which the fiber bundles or tapes are arranged in a sheet-like array and aligned parallel to one another along a common direction. Successive layers of such, unidirectional fiber bundles or tapes can be rotated with respect to the previous layer to form a relatively flexible composite. An example of such laminate structures are composites with the second, third, fourth and fifth layers rotated +45 degree, −45 degree, 90 degree and 0 degree, with respect to the first layer, but not necessarily in that order. Other examples include composites with 0 degree/90 degree layout of yarn, fiber bundles, or tapes.

To manufacture a basic or complex laminate, an adhesive or release layer is applied to at least one layer of fiber bundles or tapes. The fibers or tapes in the fiber bundle layer or tape layer may be arranged in networks having various configurations. For example, a plurality of filaments can be grouped together to form twisted or untwisted yarn bundles in various alignments. The filaments or yarn may be formed as a felt, knitted or woven (plain, basket, satin and crow feet weaves, etc.) into a network, fabricated into non-woven fabric, arranged in parallel array, layered, or formed into a woven fabric by any of a variety of conventional techniques.

The adhesive or release layers may be applied in line with the use of a continuing laminating press and can be applied at the same time as an additional adhesive layer or release layer. The present invention allows for lamination at relatively low pressures with or without fiber wet-out. A consolidation or wet-out step subsequently occurs so that the adhesive or release layer penetrates the fiber bundle. When an adhesive layer or release layer is used adjacent to a tape layer, the consolidation step may be used, or the lamination can be performed in one step. In one example, pre-lamination of the of the basic laminates may be performed at less than about 14 psi.

The subsequent consolidation or wet-out step includes application of increased pressure to the laminate. In one embodiment, the applied pressure is about 1000 psi, and other embodiments use an applied pressure up to or in excess of about 3000 psi. The pressure used is selected to achieve the pre-determined or desired degree of wet out to form a resin matrix in the fiber bundles, and is based, at least in part, on the specific fiber and adhesive being used and whether a release layer is present. The amount of pressure needed will vary depending on the particular adhesive or release layer as well as the temperature used to facilitate wet-out of the fiber bundles. The specific temperature and pressure needed to achieve the desired degree of wet out can be determined without undue experimentation. If the initial viscosity of the adhesive layer is low, as is the case for some liquid adhesives, wet out can occur at very low pressure, including atmospheric pressure. In this case, the release layer and the adhesive layer can be applied in a one-step process. Alternatively, the pressure used can be selected to achieve a desired degree of lamination in cases where at least one tape layer is used in the laminate. The specific temperature and pressure needed to achieve a desired degree of lamination of a laminate including tape layers can be determined without undue experimentation.

Complex laminates can be formed using the processes described above. In one example, basic laminates are formed first in accordance with the processes described above, appropriate control layers are placed between adjacent basic laminates as they are stacked, and heat, pressure, or both is applied to laminate the basic laminates into a complex laminate.

The fibers believed to be suitable in the fabrication of the fiber bundles vary widely and include organic or inorganic fibers having a tensile strength of at least about 5 grams/denier, a tensile modulus of at least about 30 grams/denier and an energy-to-break of at least about 8 joules/gram. The tensile properties may be measured by an Instron Tensile Testing Machine by pulling a 10 in. (25.4 cm) length of fiber clamped in barrel clamps at a rate of 10 in./min. (25.4 cm/min). Some embodiments use fibers having a tenacity equal to or greater than about 7 g/d, a tensile modulus equal to or greater than about 150 g/d, and an energy-to-break equal to or greater than about 8 joules/gram, for example, fibers having a tenacity equal to or greater than about 20 g/d, a tensile modulus equal to or greater than about 500 g/d and energy-to-break equal to or greater than about 20 joules/grams.

The invention includes embodiments in which the tenacity of the fibers is equal to or greater than about 25 g/d, the tensile modulus is equal to or greater than about 1000 g/d, and the energy-to-break is equal to or greater than about 35 joules/grams, and embodiments with a tenacity equal to or greater than about 30 g/d, the tensile modulus equal to or greater than about 1000 g/d and the energy-to-break equal to or greater than about 30 joules/grams.

The denier of the fiber may vary widely. In general, suitable fiber denier is believed to be equal to or less than about 4000. In exemplary embodiments, fiber denier is from about 10 to about 3000, such as from about 10 to about 1500 or from about 10 to about 1000.

Useful inorganic fibers are believed to include S-glass fibers, E-glass fibers, carbon fibers, boron fibers, alumina fibers, zirconia-silica fibers, alumina-silica fibers and the like.

Illustrative of organic fibers believed to be suitable are those composed of thermosetting resins, thermoplastics polymers and mixture thereof such as polyesters, polyolefins, polyetheramides, fluoropolymers, polyethers, celluloses, phenolics, polyesteramides, polyurethanes, epoxies, aminoplastics, polysulfones, polyetherketones, polyetheretherketones, polyesterimides, polyphenylene sulfides, polyether acryl ketones, poly(amideimides), and polyimides. Illustrative of other useful organic fibers are those composed of aramids (aromatic polyamides), such as poly(m-xylylene adipamide), poly(p-xylylene sebacamide), poly 2,2,2-trimethylhexamethylene terephthalamide), poly(piperazine sebacamide), poly(metaphenylene isophthalamide) (Nomex®) and poly(p-phenylene terephthalamide) (Kevlar®); aliphatic and cycloaliphatic polyamides, such as the copolyamide of 30% hexamethylene diammonium isophthalate and 70% hexamethylene diammonium adipate, the copolyamide of up to 30% bis-(-amidocyclohexyl)methylene, terephthalic acid and caprolactam, polyhexamethylene adipamide (nylon 66), poly(butyrolactam) (nylon 4), poly (9-aminonoanoic acid) (nylon 9), poly(enantholactam) (nylon 7), poly(capryllactam) (nylon 8), polycaprolactam (nylon 6), poly(p-phenylene terephthalamide), polyhexamethylene sebacamide (nylon 6,10), polyaminoundecanamide (nylon 11), polydodeconolactam (nylon 12), polyhexamethylene isophthalamide, polyhexamethylene terephthalamide, polycaproamide, poly(nonamethylene azelamide) (nylon 9,9), poly(decamethylene azelamide) (nylon 10,9), poly(decamethylene sebacamide) (nylon 10,10), poly>bis-(4-aminocyclothexyl)methane 1,10-decanedicarboxamide! (Qiana) (trans), or combination thereof; and aliphatic, cycloaliphatic and aromatic polyesters such as poly(1,4-cyclohexlidene dimethyl eneterephathalate) cis and trans, poly(ethylene-1,5-naphthalate), poly(ethylene-2,6-naphthalate), poly(1,4-cyclohexane dimethylene terephthalate) (trans), poly(decamethylene terephthalate), poly(ethylene terephthalate), poly(ethylene isophthalate), poly(ethylene oxybenozoate), poly(para-hydroxy benzoate), poly(dimethylpropiolactone), poly(decamethylene adipate), poly(ethylene succinate), polyethylene azelate), poly(decamethylene sebacate), poly(.beta.,.beta.-dimethyl-propiolactone), and the like.

Also illustrative of organic fibers believed useful are those of liquid crystalline polymers such as lyotropic liquid crystalline polymers which include polypeptides such as poly δ-benzyl L-glutamate and the like; aromatic polyamides such as poly(1,4-benzamide), poly(chloro-1,4-phenylene terephthalamide), poly(1,4-phenylene fumaramide), poly(chloro-1,4-phenylene fumaramide), poly(4,4′-benzanilide trans, trans-muconamide), poly(1,4-phenylene mesaconamide), poly(1,4-phenylene) (trans-1,4-cyclohexylene amide), poly(chloro-1,4-phenylene) (trans-1,4-cyclohexylene amide), poly(1,4-phenylene 1,4-dimethyl-trans-1,4-cyclohexylene amide), poly(1,4-phenylene 2,5-pyridine amide), poly(chloro-1,4-phenylene 2,5-pyridine amide), poly(3,3′-dimethyl-4,4′-biphenylene 2.5 pyridine amide), poly(1,4-phenylene 4,4′-stilbene amide), poly(chloro-1,4-phenylene 4,4′-stilbene amide), poly(1,4-phenylene 4,4′-azobenzene amide), poly(4,4′-azobenzene 4,4′-azobenzene amide), poly(1,4′-phenylene 4,4′-azoxybenzene amide), poly(4,4′-azobenzene 4,4′-azoxybenzene amide), poly(1,4-cyclohexylene 4,4′-azobenzene amide), poly(4,4′-azobenzene terephthal amide), poly(3,8-phenanthridinone terephthal amide), poly(4,4′-biphenylene terephthal amide), poly(4,4′-biphenylene 4,4′-bibenzo amide), poly(1,4-phenylene 4,4′-bibenzo amide), poly(1,4-phenylene 4,4′-terephenylene amide), poly(1,4-phenylene 2,6-naphthal amide), poly(1,5-naphthylene terephthal amide), poly(3,3′-dimethyl-4,4-biphenylene terephthal amide), poly(3,3′-dimethoxy-4,4′-biphenylene terephthal amide), poly(3,3′-dimethoxy-4,4-biphenylene 4,4′-bibenzo amide) and the like; polyoxamides such as those derived from 2,2′ dimethyl-4,4′ diamino biphenyl and chloro-1,4-phenylene diamine; polyhydrazides such as poly chloroterephthalic hydrazide, 2,5-pyridine dicarboxylic acid hydrazide) poly(terephthalic hydrazide), poly(terephthalic-chloroterephthalic hydrazide) and the like; poly(amide-hydrazides) such as poly(terephthaloyl 1,4 amino-benzhydrazide) and those prepared from 4-amino-benzhydrazide, oxalic dihydrazide, terephthalic dihydrazide and para-aromatic diacid chlorides; polyesters such as those of the compositions include poly(oxy-trans-1,4-cyclohexyleneoxycarbonyl-trans-1,4-cyclohexylenecarbonyl 1-β-oxy-1,4-phenyl-eneoxyterephthaloyl) and poly(oxy-cis-1,4-cyclohexyleneoxycarbonyl-trans-1,4-cyclohexylenecarbonyl-β-oxy-1,4-phenyleneoxyterephthaloyl) in methylene chloride-o-cresol poly>(oxy-trans-1,4-cyclohexylene-oxycarbonyl-trans-1,4-cyclohexylenecarbonyl-(β-oxy-(2-methyl-1,4-phenylene)oxy-terephthaloyl)! in 1,1,2,2-tetrachloroethane-o-chlorophenol-phenol (60:25:15 vol/vol/vol), poly-oxy-trans-1,4-cyclohexyleneoxycarbonyl-trans-1,4-cyclohexylenecarbonyl 1-β-oxy(2-methyl-1,3-phenylene)oxy-terephthaloyl in o-chlorophenol and the like; polyazomethines such as those prepared from 4,4′-diaminobenzanilide and terephthalaldephide, methyl-1,4-phenylenediamine and terephthalaldelyde and the like; polyisocyanides such as poly(-phenyl ethyl isocyanide), poly(n-octyl isocyanide) and the like; polyisocyanates such as poly(n-alkyl isocyanates) as for example poly(n-butyl isocyanate), poly(n-hexyl isocyanate) and the like; lyrotropic crystalline polymers with heterocylic units such as poly(1,4-phenylene-2,6-benzobisthiazole) (PBT), poly(1,4-phenylene-2,6-benzobisoxazole) (PBO), poly(1,4-phenylene-1,3,4-oxadiazole), poly(1,4-phenylene-2,6-benzobisimidazole), poly-2,5(6)-benzimidazole (AB-PBI), poly-2,6-(1,4-phenylene)-4-phenylquinoline, poly-1,1′-(4,4′-biphenylene)-6,6′-bis(4-phenylquinoline) and the like; polyorganophosphazines such as polyphosphazine, polybisphenoxyphosphazine, poly-bis(2,2,2′ trifluoroethyelene)phosphazine and the like; metal polymers such as those derived by condensation of trans-bis(tri-n-butylphosphine)platinum dichloride with a bisacetylene or trans-bis(tri-n-butylphosphine)bis(1,4-butadinynyl)platinum and similar combinations in the presence of cuprous iodine and an amide; cellulose and cellulose derivatives such as esters of cellulose as for example triacetate cellulose, acetate cellulose, acetate-butyrate cellulose, nitrate cellulose, and sulfate cellulose, ethers of cellulose as for example, ethyl ether cellulose, hydroxymethyl ether cellulose, hydroxypropyl ether cellulose, carboxymethyl ether cellulose, ethyl hydroxyethyl ether cellulose, cyanoethylethyl ether cellulose, ether-esters of cellulose as for example acetoxyethyl ether cellulose and benzoyloxypropyl ether cellulose, and urethane cellulose as for example phenyl urethane cellulose; thermotropic liquid crystalline polymers such as celluloses and their derivatives as for example hydroxypropyl cellulose, ethyl cellulose propionoxypropyl cellulose, thermotropic liquid crystalline polymers such as celluloses and their derivatives as for example hydroxypropyl cellulose, ethyl cellulose propionoxypropyl cellulose; thermotropic copolyesters as for example copolymers of 6-hydroxy-2-naphthoic acid and p-hydroxy benzoic acid, copolymers of 6-hydroxy-2-naphthoic acid, terephthalic acid and p-amino phenol, copolymers of 6-hydroxy-2-naphthoic acid, terephthalic acid and hydroquinone, copolymers of 6-hydroroxy-2-naphtoic acid, p-hydroxy benzoic acid, hydroquinone and terephthalic acid, copolymers of 2,6-naphthalene dicarboxylic acid, terephthalic acid, isophthalic acid and hydroquinone, copolymers of 2,6-naphthalene dicarboxylic acid and terephthalic acid, copolymers of p-hydroxybenzoic acid, terephthalic acid and 4,4′-dihydroxydiphenyl, copolymers of p-hydroxybenzoic acid, terephthalic acid, isophthalic acid and 4,4′-dihydroxydiphenyl, p-hydroxybenzoic acid, isophthalic acid, hydroquinone and 4,4′-dihydroxybenzophenone, copolymers of phenylterephthalic acid and hydroquinone, copolymers of chlorohydroquinone, terephthalic acid and p-acetoxy cinnamic acid, copolymers of chlorohydroquinone, terephthalic acid and ethylene dioxy-4,4′-dibenzoic acid, copolymers of hydroquinone, methylhydroquinone, p-hydroxybenzoic acid and isophthalic acid, copolymers of (1-phenylethyl)hydroquinone, terephthalic acid and hydroquinone, and copolymers of poly(ethylene terephthalate) and p-hydroxybenzoic acid; and thermotropic polyamides and thermotropic copoly(amide-esters).

Also illustrative of useful organic fibers believed to be useful in the fabrication of fiber bundles 12 are those composed of extended chain polymers formed by polymerization of α,β-unsaturated monomers of the formula:

R₁R₂—C═CH₂

wherein:
R₁ and R₂ are the same or different and are hydrogen, hydroxy, halogen, alkylcarbonyl, carboxy, alkoxycarbonyl, heterocycle or alkyl or aryl either unsubstituted or substituted with one or more substituents selected from the group consisting of alkoxy, cyano, hydroxy, alkyl and aryl. Illustrative of such polymers of α,β-unsaturated monomers are polymers including polystyrene, polyethylene, polypropylene, poly(1-octadence), polyisobutylene, poly(1-pentene), poly(2-methylstyrene), poly(4-methylstyrene), poly(1-hexene), poly(1-pentene), poly(4-methoxystrene), poly(5-methyl-1-hexene), poly(4-methylpentene), poly(1-butene), polyvinyl chloride, polybutylene, polyacrylonitrile, poly(methyl pantene-1), poly(vinyl alcohol), poly(vinyl-acetate), poly(vinyl butyral), poly(vinyl chloride), poly(vinylidene chloride), vinyl chloride-vinyl acetate chloride copolymer, poly(vinylidene fluoride), poly(methyl acrylate, poly(methyl methacrylate), poly(methacrylo-nitrile), poly(acrylamide), poly(vinyl fluoride), poly(vinyl poly(3-methyl-1-butene), poly(1-pentene), poly(4-methyl-1-butene), poly(1-pentene), poly(4-methyl-1-pentence, poly(1-hexane), poly(5-methyl-1-hexene), poly(1-octadence), poly(vinyl-cyclopentane), poly(vinylcyclothexane), poly(a-vinyl-naphthalene), poly(vinyl methyl ether), poly(vinyl-ethylether), poly(vinyl propylether), poly(vinyl carbazole), poly(vinyl pyrolidone), poly(2-chlorostyrene), poly(4-chlorostyrene), poly(vinyl formate), poly(vinyl butyl ether), poly(vinyl octyl ether), poly(vinyl methyl ketone), poly(methyl-isopropenyl ketone), poly(4-phenylstyrene) and the like.

In some embodiments, composite articles include a fiber network, which may include a high molecular weight polyethylene fiber, a high molecular weight polypropylene fiber, an aramide fiber, a high molecular weight polyvinyl alcohol fiber, a high molecular weight polyacrylonitrile fiber or mixtures thereof. In the case of polyethylene, suitable fibers are believed to be those of molecular weight of at least 150,000, preferably at least one million and more preferably between two million and five million. Such extended chain polyethylene (ECPE) fibers may be grown in solution, or a filament spun from a solution to form a gel structure, as is known. As used herein, the term polyethylene shall mean a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as anti-oxidants, lubricants, ultra-violet screening agents, colorants and the like which are commonly incorporated. Depending upon the formation technique, the draw ratio and temperatures, and other conditions, a variety of properties can be imparted to these fibers.

Similarly, highly oriented polypropylene fibers of molecular weight at least 200,000, preferably at least one million and more preferably at least two million may be used. Such high molecular weight polypropylene may be formed into reasonably well oriented fibers by the techniques known. Since polypropylene is a much less crystalline material than polyethylene and contains pendant methyl groups, tenacity values achievable with polypropylene are generally substantially lower than the corresponding values for polyethylene. Accordingly, a suitable tenacity is at least 8 grams/denier, such as at least 11 grams/denier. The tensile modulus (as measured by an Instron Tensile Testing Machine) for polypropylene is at least 160 grams/denier, for example, at least about 200 grams/denier. These ranges for the above-described parameters can advantageously provide improved performance in the final article.

High molecular weight polyvinyl alcohol fibers having high tensile modulus are believed suitable for the present invention. In the case of polyvinyl alcohol (PV-OH), PV-OH fiber of molecular weight of at least about 200,000 may be particularly suitable. Particularly useful PV-OH fiber preferably has a tensile modulus (as measured by an Instron Tensile Testing Machine) of at least about 300 g/d, a tenacity of at least 7 g/d (such as at least about 10 g/d, 14 g/d, or 17 g/d), and an energy-to-break of at least about 8 joules/gram. PV-OH filaments having a weight average molecular weight of at least about 200,000, a tenacity of at least about 10 g/d, a tensile modulus (as measured by an Instron Tensile Testing Machine) of at least about 300 g/d, and an energy-to-break of about 8 joules/gram is useful in producing a ballistic resistant article. PV-OH fiber having such properties can be produced by known methods.

Polyacrylonitrile (PAN) fiber of molecular weight of at least about 400,000 is believed to be suitable. Particularly useful PAN filament should have a tenacity of at least about 10 g/d (as measured by an Instron Tensile Testing Machine) and an energy-to-break of at least about 8 joules/gram. PAN fiber having a molecular weight of at least about 400,000, a tenacity of at least about 15 to about 20 g/d and an energy-to-break of at least 8 joules/gram is useful in producing ballistic resistant articles.

In the case of aramid fibers, suitable aramid fibers formed principally from aromatic polyamide are known. Preferred aramid fiber will have a tenacity of at least about 20 g/d (as measured by an Instron Tensile Testing Machine), a tensile modulus of at least about 400 g/d (as measured by an Instron Tensile Testing Machine) and an energy-to-break at least about 8 joules/gram, and particularly preferred aramid fibers will have a tenacity of at least about 20 g/d, a modulus of at least about 480 g/d and an energy-to-break of at least about 20 joules/gram. Some of the useful aramid fibers will have a tenacity of at least about 20 g/denier, a modulus of at least about 900 g/denier and an energy-to-break of at least about 30 joules/gram. For example, poly(phenylene terephthalamide) fibers produced commercially by Dupont Corporation under the trade name of Kevlar® 29, 49, 129 and 149 having moderately high modulus and tenacity values are believed particularly useful in forming ballistic resistant composites. Also believed useful in the practice of this invention is poly(metaphenylene isophthalamide) fibers produced commercially by Dupont under the tradename Nomex®.

In the case of liquid crystal copolyesters, suitable fibers are known. Tenacities of about 15 to about 30 g/d (as measured by an Instron Tensile Testing Machine), including about 20 to about 25 g/d, and tensile modulus of about 500 to 1500 g/d (as measured by an Instron Tensile Testing Machine) including about 1000 to about 1200 g/d are useful. Fibers made under the trade name Vectran®, by Celanese corporation are believed very suitable. Some useful fibers for use in the fiber network are Vectran LCP, and PBO fibers. Other useful fibers are Aramid fibers sold under the trade name Kevlar® and Twaron®, and high performance polyethylene sold under the trade name Spectra® (Honeywell) and Dyneema® (DSM Corporation).

Suitable tapes include, but are not limited to, nylon, polypropylene, and polyethelyene tapes. For example, highly oriented polyethylene tape, such as Tenslyon manufactured by Integrated Textiles, Monroe, N.C. may be used.

Any suitable adhesive may be used in the formation of the basic laminates and as the control layer in complex laminates. The adhesive layer can be made of any number of suitable polymeric adhesives. The adhesive can be of a thermosetting or thermoplastic type. Adhesives believed suitable include polydienes such as polybutadiene, polychloroprene and polysioprene; olefinic and copolymers such as ethylene-propylene, ethylene-propylene copolymers, ethylene-propylene-diene terpolymers, ethylene-chloropylene-diene copolymers, isobutylene-soprene copolymer, and chlorosulfonated polyethylene; natural rubber, polysulfides, polyurethane elastomers; polychloroprene, poly(isobutyleneco-isoprene); polyacrylates; polyethers; fluoroelastomer; unsaturated polyesters; vinyl esters; alkyds; flexible epoxy, flexible polyamides, flexible nylon; epichlorophydrin; polyvinyls; flexible phenolics; silicon elastomers; thermoplastic elastomers; copolymers of ethylene, polyvinyl formal, polyvinyl butyral; and poly(bis-maleimide). Blends of and combinations of one or more of the above-mentioned adhesive materials are also believed suitable.

Useful adhesive material includes a low to mid-modulus, elastomeric material which has a tensile modulus, measured at about 23° C., of greater than about 100 psi (41,300 kpa), such as above 3000 psi and above 7000 psi, but less than 80,000 psi. The elastomeric material has an elongation to break of at least about 5%, such as at least about 30%, 50%, or 100%. Representative examples of elastomeric materials believed suitable for use as a flexible adhesive include block copolymers of conjugated dienes such as butadiene and isoprene, and vinyl aromatic monomers such as styrene, vinyl toluene and t-butyl styrene; polydienes such as polybutadiene and polychloroprene, polyisoprene; natural rubber; copolymers and polymers of olefins and dienes such as ethylene-propylene copolymers, ethylene-propylene-diene terpolymers and poly(isobutylene-co-isoprene), polyfulfide polymers, polyurethane elastomers, and chlorosulfonated polyethylene; pasticized polyvinylchloride using dioctyl phthate or other plasticizers well known in the art; butadiene acrylonitrile elastomers; polyacrylates such as poly(acrylic acid), poly(methylcyanoacrylate), poly(methylacrylate), poly(ethyl acrylate), poly(propylacrylate), poly(methylacrylonitrile), poly(acrylamide), poly(N-isopropylacrylamide) and the like, polyesters; polyethers; fluoroelastomers; poly(bismaleimide); flexible epoxies; flexible phenolics; polyurethanes; silicone elastomers; flexible polyamides; unsaturated polyesters; vinyl easters, polyolefins, such as polybutylene and polyethylene; polyvinyls such as poly(vinyl formate), poly(vinylbenzoate), poly(vinyl-carbazole), poly(vinylmethylketone), poly(vinyl-methyl ether), polyvinyl acetate, polyvinyl butyral, and poly(vinyl formal); and polyolefinic elastomers.

One form for the adhesive is a non-woven spun adhesive. Examples of these polymeric materials are sold under the trade name Spunfab®, by Spunfab Corporation, Cuyahoga Falls, Ohio, and under the trade name Sharenet®, by Bostik Corporation, Middleton, Mass. Particularly useful adhesives include Spunfab® Ternary Resins; polyamides and polyesters; and EAV and polyolefins.

Another form for the adhesive is a continuous sheet of film. Examples of such a film is sold under the trade name Duraflex TPU, by Deerfield Urethane.

Any suitable release layer can be used in the formation of the basic laminates and as a control layer. The release layer can be any suitable material that results in a lower inter-laminar shear when combined with the adhesive layer or another release layer. In some cases, the release layer has some adherence to an adjacent adhesive layer. Suitable materials include paper, metal foil, or plastic film. Suitable plastic films include polyester, polypropylene or urethane, particularly those polyethylene films with an areal weight less than 50 grams per sq meter, including those polyethylene films with an areal weight less than 8 grams per sq meter. Suitable release layers also include silicone-based release agents or other release agents that may be used with adhesives. For example, lower inter-laminar shear can also be obtained with the application of a release agent such as silicone to the release film or the adhesive layer prior to bonding. This approach allows tailoring the inter-laminar shear to meet a specific ballistic requirement. In one example, the release layer comprises polyethylene film of less than 0.0005″ thickness.

The articles of this invention can be fabricated using any suitable procedures. For example, articles are formed by molding the combination of the basic laminates stacked to form complex laminates in the desired configurations and amounts by subjecting the combination to heat and pressure during a mold cycle time. The molding temperature is usually selected such that it is less than the melting or softening point of the polymer from which the fibers of the fiber bundle layer are formed or the temperature at which fiber damage occurs, but is greater than the melting point or softening point of the polymer or polymers forming release or adhesive layer(s). For example, for extended chain polyethylene filaments, molding temperatures range from about 20° to about 150° C., such as from about 80° to about 145° C., or from about 100° to about 135° C. The molding pressure may vary widely and preferably may range from about 10 psi (69 kPa) to about 30,000 psi (207,000 kPa). A pressure between about 10 psi (69 kPa) and about 100 psi (690 kPa), when combined with temperatures above about 100° C. for a period of time less than about 1.0 minute, may be used simply to cause the fibrous layers and polymeric adhesive layers to stick together prior to additional heat and pressure being applied to cause the formation of a resin matrix.

For fibers such as Aramid® and Vectran® LCP, molding temperatures can approach 250° C., and the limiting factor is the temperature capability of the adhesive and the release layer, which will vary greatly depending on the particular material.

### EXAMPLES

To illustrate the effect of reducing inter-laminar shear with the addition of release layers in a ballistic laminate, a laminate was made using Kevlar fiber. The laminate incorporated an adhesive layer made of Spunfab 80410 non-woven web adhesive which was applied to a unidirectional array of Kevlar fibers and subsequently wet out under heat and pressure. The release layer as a control layer was a 0.00035″ thick polyethylene film. The addition of the release layers as control layers in the laminate resulted in a reduction of inter-laminar shear of 31% and an increase of V50 ballistic performance by 8.9% as compared to a similar laminate made without the release layer.

V50 testing identifies the average velocity at which a bullet or a fragment penetrates the armor equipment in 50% of the shots, versus non-penetration of the other 50%. Testing was conducted in conducted in accordance will MIL STD 662B.

### Example #1

BALLISTICS(V50) VS CLIMBING DRUM PEEL ASTM 1781-98 30 CAL FSP

| | | | PEEL STRENGTH | | | |
|---|---|---|---|---|---|---|
| TARGET | | | INCH | % REDUCTION | # RELEASE | AREAL |
| ID# | DESCRIPTION | V50 | POUND/POUND | PEEL STRENGTH | LAYERS | DENSITY |
| 3088-36 | ADHESIVE | 3494 | 1.86 | 0 | 0 | 5 |
| | ONLY | | | | | |
| HA-3000-1 | ADHESIVE + | 3807 | 1.29 | 31% | 220 | 5 |
| | RELEASE | | | | | |

The addition of release layers as control layers that result in a reduction of inter-laminar shear by at least 10% is considered beneficial to the ballistic performance.

The invention shows surprising results when compared to the known art. Surprisingly, the present invention, an embodiment of which is illustrated below as Example #2 incorporating 58 release layers as control layers, shows an improved V50 ballistic result against a 9 mm threat, despite a resin modulus over 200 times higher. Example #3, with 220 release layers as control layers, illustrates the same surprising results.

The ballistic performance of the articles of the present invention is surprisingly affected by the degree of wet-out. Some embodiments of the present invention include fibers that are partially wet out, and other embodiments of the present invention include fibers that are approximately fully wet-out.

The benefit on ballistic performance of having the fibers at least partially wet-out is demonstrated in example #4 and example #5. Ballistic laminates were made into a 0/90 degree two-ply basic laminate and subsequently processed in a compression molding press under three different pressures. The higher the pressure, the more wet of the fibers occurred. Surprisingly, the materials that are more wet-out exhibit substantially better ballistic results, despite the additional weight of the adhesive. This is contrary to conventional teaching that better ballistic results occur without wetting out the fibers. Example #5 demonstrated the same effect on a hard armor panel.

Example #4 demonstrates that, surprisingly, ballistic performance increases with fiber wet-out. The tested sample increased 4.4% with partial wet-out and 9% with full wet-out. In example #5, the performance surprisingly increased by 9.9%.

A surprising effect of the release layer is also demonstrated in example #6. It has long been held in the industry that resins are parasitic in nature and do not add to the ballistic performance. Since the reinforcing fiber has the strength, it is generally held that more fiber in a ballistic laminate will yield higher ballistic properties. In example #6, articles were made using the same adhesive resin matrix, at the same areal density, and at various resin contents. One sample included 58 layers of a 0.00035″ polyethylene film as a release layer between each of the 58 layers of the laminate. Surprisingly, a laminate with 85% fiber made under this invention performed 4.4% higher as compared to a laminate with 95% fiber content.

Increasing the number of release layers as control layers improves the resulting ballistic performance. To demonstrate this, three test samples using a different number of release layers as control layers were constructed. The fiber content was held constant, with layers of release materials displacing layers of adhesive. The resulting ballistic performance confirms that more release layers improves performance, as illustrated in Example #7.

Military specifications have been developed for acceptable spall-liner materials. A 30 caliber fragment simulating projectile is used to evaluate performance. Materials weighing 5 pounds per square foot must meet a minimum V50 performance of 2400 ft per second. Example #8 shows that the Aramid Shield product made in accordance with this invention exceeded the military specification requirement at a weight of 3.3 pounds per square foot.

To demonstrate the cost effectiveness of this material, example #9 compares several high performance materials and compares the cost per unit of specific energy absorption. Articles made in accordance with this invention not only perform very well, they are also cost effective.

Laminates were made and tested to demonstrate the use of a non-woven adhesive layer as the control layer. One laminate was made using a wet pre-impregnation of a uni-directional network of fibers with a layer of non-woven Spunfab adhesive disposed between the twenty four (24) layers of the laminate. Another laminate was made where the process co-mingled the non-woven adhesive layer and the pvb-phenolic resin, effectively eliminating the release layer. Both laminates were tested and compared against 30 cal fragment simulating projectile. The results in example #10 show a 14.3% improvement in the sample were the non-woven adhesive is allowed to act as a release layer.

The SAPI (Small arms protective insert) application is a good example of where this material can be utilized in conjunction with ceramic materials to defeat multiple threats. This invention can be incorporated as a backing to a ceramic facing and is very suitable for this application. The material has been tested against the requirements for a standard army SAPI plate and has passed the tests required for 7.62 M80 ball, M855 and LPS ball rounds.

Another useful embodiment of the invention is as a soft armor material in ballistic vests. Because the material of the present invention is bonded with an adhesive layer as opposed to a non-adhesive film layer, the structural integrity of the flexible product is greatly enhanced. The benefit is more durability during long term use. Suitability is demonstrated by example 11, which demonstrates compliance with the National Institute for Justice (NIJ) standards for commercial body armor.

### Example #2

BALLISTICS(V50) ARAMID SHIELD VS LOW MODULUS
RESIN MATRIX, KEVLAR FIBER, 9 MM BULLET, RIGID
ARMOR

| | | | AREAL | | # |
|---|---|---|---|---|---|
| TARGET | | V50 | DEN- | RESIN | RELEASE |
| ID# | DESCRIPTION | ft/sec | SITY | MODULUS | LAYERS |
| 3086B- | ARAMID | 1924 | 1.3 | 24000 | 58 |
| 26000-1 | SHIELD ™, | | | | |
| | POLYOLEFIN | | | | |
| | RESIN | | | | |
| CS- | ARAMID | 1860 | 1.3 | 200 | 0 |
| 1000-2 | SHIELD ™, | | | | |
| | URETHANE | | | | |
| | RESIN | | | | |

### Example #3

BALLISTICS(V50) ARAMID SHIELD VS LOW MODULUS RESIN
MATRIX, KEVLAR FIBER

| | | | | # |
|---|---|---|---|---|
| | V50 | AREAL | RESIN | RELEASE |
| DESCRIPTION | ft/sec | DENSITY | MODULUS | LAYERS |
| ARAMID SHIELD ™, | 3807 | 5 | 24000 | 220 |
| POLYOLEFIN | | | | |
| RESIN | | | | |
| ARAMID SHIELD ™, | 3469 | 5 | 200 | 0 |
| URETHANE | | | | |
| RESIN | | | | |

### Example #4

### Ballistics Vs the Degree of Fiber Wet-Out

BALLISTICS(V50) VS THE DEGREE OF WET-OUT, 9 MM BULLET, SOFT ARMOR PANEL

| | | MOLDING | | | | |
|---|---|---|---|---|---|---|
| TARGET | | PRESSURE | V50 | V0 | AREAL | WET OUT |
| ID# | DESCRIPTION | (PSI) | ft/sec | PENETRATIONS | DENSITY | CONDITION |
| 3B/3A | ARAMID SHIELD ™ | 3000 | 1620 | 0/6 | 1.1 | FULLY |
| | | | | | | WET-OUT |
| 8B/8A | ARAMID SHIELD ™ | 800 | 1551 | 3/6 | 1.1 | PARTIALLY |
| | | | | | | WET-OUT |
| 2B/2A | ARAMID SHIELD ™ | 200 | 1485 | 6/6 | 1.1 | NOT |
| | | | | | | WET-OUT |

### Example #5

### Wet Out Vs Non-Wet Out Material

BALLISTICS(V50) WET-OUT
9 MM, RIGID ARMOR PANEL

| | | MOLDING | | | WET OUT |
|---|---|---|---|---|---|
| TARGET | DES- | PRESSURE | V50 | AREAL | CON- |
| ID# | CRIPTION | (PSI) | ft/sec | DENSITY | DITION |
| 3086B- | ARAMID | 3000 | 1924 | 1.3 | COMPLETE |
| 26000-1 | SHIELD ™, | | | | WET-OUT |
| | PRESS | | | | |
| | MOLDED | | | | |
| 3086B- | ARAMID | 14 | 1750 | 1.3 | NOT WET- |
| 27000-1 | SHIELD ™, | | | | OUT |
| | VAC BAG | | | | |

### Example #6

BALLISTICS(V50) ARAMID SHIELD VS HIGHER FIBER
CONTENT 9 MM, RIGID ARMOR PANEL, KEVLAR FIBER

| TARGET | | V50 | AREAL | RESIN | # RELEASE | FIBER |
|---|---|---|---|---|---|---|
| ID# | DESCRIPTION | ft/sec | DENSITY | MODULUS | LAYERS | CONTENT % |
| 3086B- | ARAMID SHIELD ™, | 1924 | 1.3 | 24000 | 58 | 85% |
| 26000-1 | POLYOLEFIN RESIN | | | | | |
| 3086- | ARAMID SHIELD, ALL | 1836 | 1.3 | 24000 | 0 | 96% |
| C11 | ADHESIVE | | | | | |

### Example #7

BALLISTICS(V50) ARAMID SHIELD VS # RELEASE
LAYERS
.30 CAL FSP, RIGID ARMOR PANEL,
KEVLAR FIBER

| | | | | # | FIBER |
|---|---|---|---|---|---|
| TARGET | DES- | V50 | AREAL | RELEASE | CONTENT |
| ID# | CRIPTION | ft/sec | DENSITY | LAYERS | % |
| HA-3000-1 | ARAMID | 3807 | 5 | 220 | 85% |
| | SHIELD ™ | | | | |
| SA-3000-1 | ARAMID | 3515 | 5 | 110 | 85% |
| | SHIELD ™ | | | | |
| 3088-17 | ARAMID | 3494 | 5 | 0 | 85% |
| | SHIELD ™ | | | | |

### Example #8

BALLISTICS(V50) ARAMID SHIELD ™ VS # RELEASE
LAYERS
.30 CAL FSP, RIGID ARMOR
PANELS

| | | | | # | % |
|---|---|---|---|---|---|
| TARGET | | V50 | AREAL | RELEASE | WEIGHT |
| ID# | DESCRIPTION | ft/sec | DENSITY | LAYERS | SAVINGS |
| HA- | MIL SPEC | 2400 | 5 | 0 | |
| 3000-1 | KEVLAR, | | | | |
| | PVB | | | | |
| SA- | MIL SPEC, | 2400 | 5 | 0 | |
| 3000-1 | S-2 GLASS | | | | |
| 3088-44 | ARAMID | 2786 | 3.3 | 145 | 34% |
| | SHIELD ™ | | | | |

### Example #9

BALLISTICS(V50) ARAMID SHIELD ™ VS SPECTRA
SHIELD
.30 CAL FSP, RIGID ARMOR PANEL

| | | | | # | |
|---|---|---|---|---|---|
| TARGET | | V50 | AREAL | RELEASE | |
| ID# | DESCRIPTION | ft/sec | DENSITY | LAYERS | $/SEA |
| 3088-44 | ARAMID | 2786 | 3.3 | 145 | $0.29 |
| | SHIELD ™ | | | | |
| 3086B- | MIL SPEC | 2251 | 3.3 | 0 | $0.41 |
| 14000-1 | KEVLAR, PVB | | | | |
| 3086B- | SPECTRA | 2977 | 3.3 | 0 | $0.44 |
| 14000-1 | SHIELD TM | | | | |
| | HONEYWELL | | | | |
| 3086- | KEVLAR KM2 | 2388 | 3.3 | 0 | $0.54 |
| 15000-1 | PVB | | | | |

### Example #10

BALLISTICS(V50) LAMINATE MADE WITH WET PRE-
PREG AND NON-WOVEN ADHESIVE AS RELEASE
LAYER
.30 CAL FSP, RIGID ARMOR
PANEL

| | | | | # | |
|---|---|---|---|---|---|
| TARGET | DES- | V50 | AREAL | RELEASE | |
| ID# | CRIPTION | ft/sec | DENSITY | LAYERS | |
| 3133-05- | ARAMID | 2579 | 3.3 | 24 | LAYERED |
| 3000X | SHIELD ™, | | | | RESIN, |
| | SPUNFAB + | | | | SPUNFAB |
| | PVB | | | | ADHESIVE |
| | | | | | AS RELEASE |
| | | | | | LAYER |
| 3133-06- | ARAMID | 2256 | 3.3 | 0 | CO-MINGLED |
| 3000U | SHIELD ™, | | | | RESIN |
| | SPUNFAB + | | | | |
| | PVB | | | | |

### Example #11

### Samples Tested Against NIJ 04 Body Armor Standard

| Projectile | Material | Ballistic Result |
|---|---|---|
| 9 MM V50 | Aramid Shield ™ | 1924 ft/sec |
| 9 MM V0 | Aramid Shield ™ | NO |
| | | PENETRATION |
| 44 MAG V50 | Aramid Shield ™ | 1699 ft/sec |
| 44 MAG V0 | Aramid Shield ™ | NO |
| | | PENETRATION |

FIG. 6 illustrates an embodiment for soft armor. In this embodiment, the unidirectional fiber bundles are coated with adhesive on both outer surfaces of the fiber bundles, and the release layer as a control layer is laminated to one of the adhesive layers. The material is then cross plied (0/90) at a 90 degree orientation with a similar layer. The two layers are laminated under heat and pressure. The number of [0,90] layers is generally less than 5 and may be less than three. The orientation between layers can vary, with each layer at some angle to the other, for example, [0,90], [0,90,−45,45], [−45,45,−45,45], etc., as discussed above. Layers can be arranged, so that release layers adjoin other release layers, release layers adjoin adhesive layers, or adhesive layers. Particular lay-ups depend greatly on the particular threat and the desired ballistic result and may be selected without departing from the spirit and scope of the invention.

Other forms of the complex composite which are believed useful in this invention are, for example, a composite comprising multiple alternating layers of composite laminate and rigid layer.

The rigid layers generally include an impact resistant material, such as steel plate or composite armor plate, ceramic, such as silicone carbide, boron carbide or aluminum oxide, reinforced metallic composite, and high strength fiber composites (for example, an aramid fiber and a high modulus, resin matrix such as epoxy or phenolic resin vinyl ester, unsaturated polyester, thermoplastics, nylon 6, nylon 6, 6 and polyvinylidine halides.) In some examples, the rigid impact resistant layer is one that is ballistically effective.

Without desiring to be bound to any particular theory, it is possible that the wet-out between the fiber bundles achieved by use of the adhesive or release layer that substantially penetrates into the fiber bundle filaments allows for better energy distribution within the layer. The control layer of the present invention may or may not be the sole adhesion layer among fibers of the fiber bundles, but in either case, helps minimize inter-laminar shear strength during ballistic impact. Reducing inter-laminar shear strength is believed to help the panels or layers delaminate and absorb energy during the ballistic event.

While the control layer allows for increased energy absorption through delamination upon ballistic impact, utilizing a layer that wets out the filaments in the layers also improves the durability of the overall laminate structure, especially when used a dual layer soft armor product.

While the present invention has been illustrated by the above description of embodiments, and while the embodiments have been described in some detail, it is not the intention of the applicant to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and descried. Accordingly, departures may be made from such details without departing from the spirit or scope of the applicant's general or inventive concept.

I claim:

1. A laminate sheet for use in a ballistic structure, comprising:
a first layer of fiber bundles having an adhesive layer or a release layer;
at least a second layer of fiber bundles and laminated to the first layer and oriented at an angle between 0 and 180 degrees relative to the first layer to form a laminate sheet; and
at least one additional adhesive layer or release layer, wherein:
at least one of the first layer or second layer has an adhesive layer or release layer penetrating the fiber bundles;
the laminate sheet has at least one adhesive layer or release layer adjacent to another adhesive layer or release layer; and
at least one of the adjacent adhesive or release layers are chosen to control the inter-laminar shear properties between at least one of the adjacent layers in the laminate sheet.

2. The laminate sheet of claim 1, wherein the laminate sheet has at least an adjacent first adhesive layer and second adhesive layer.

3. The laminate sheet of claim 2, wherein the bonding strength between the first adhesive layer and the second adhesive layer is at least 15% less than the bonding strength if either adhesive were bonded to itself.

4. The laminate sheet of claim 1, wherein the at least one of the adjacent adhesive or release layers are chosen to reduce the inter-laminar shear properties between at least one of the adjacent layers in the laminate sheet.

5. The laminate sheet of claim 1, wherein the laminate sheet has at least an adjacent adhesive layer and release layer, and wherein the release layer exhibits poor bonding qualities to the adhesive.

6. The laminate sheet of claim 1, wherein the laminate sheet has at least an adjacent first release layer and second release layer.

7. The laminate sheet of claim 1, further comprising at least one control layer to control the inter-laminar shear properties between at least one of the adjacent layers in the laminate sheet.

8. The laminate sheet of claim 7, wherein the control layer is a release layer.

9. The laminate sheet of claim 8, wherein: the release layer is adjacent to the first layer of fiber bundles; the first layer of fiber bundles has an adhesive penetrating the fiber bundles; and the release layer exhibits poor bonding qualities to the adhesive.

10. The laminate sheet of claim 8, wherein the release layer is adjacent to the first layer of fiber bundles, and wherein the first layer of fiber bundles has a release layer penetrating the fiber bundles.

11. The laminate sheet of claim 8, wherein the release layer comprises polyester film, polypropylene film, polyethylene film, urethane film, aluminum foil, steel foil, titanium foil, brass foil, copper foil, paper, or an applied liquid or dry powder coating.

12. The laminate sheet of claim 7, wherein the control layer comprises an adhesive layer.

13. The laminate sheet of claim 12, wherein the adhesive layer is adjacent to the first layer of fiber bundles and wherein the first layer of fiber bundles has a release layer penetrating the fiber bundles.

14. The laminate sheet of claim 12, wherein the adhesive layer is adjacent to the first layer of fiber bundles and wherein the first layer of fiber bundles has an adhesive penetrating the first layer of fiber bundles.

15. The laminate of claim 12, wherein the adhesive layer comprises a non-woven spun bond adhesive.

16. The laminate sheet of claim 1, wherein at least one of the first layer and the second layer comprise unidirectionally-oriented fiber bundles.

17. The laminate sheet of claim 16, wherein the unidirectionally-oriented fiber bundles comprise fibers selected from the group consisting of fiberglass, nylon, polypropylene, polyethylene, aramid, and liquid crystalline polymer.

18. The laminate sheet of claim 1, wherein the first layer and the second layer are oriented at non-zero angle relative to each other.

19. The laminate sheet of claim 1, wherein the laminate sheet further comprises a third layer of tapes laminated to the first and second layers of fiber bundles.

20. A ballistic structure comprising the laminate sheet of claim 1.

21. A laminate sheet for use in a ballistic structure, comprising:
a first layer of tapes having an adhesive layer or a release layer;
at least a second layer of tapes laminated to the first layer and oriented at an angle between 0 and 180 degrees relative to the first layer to form a laminate sheet; and
at least an additional adhesive layer or release layer, wherein the laminate sheet has at least one adhesive layer or release layer adjacent to another adhesive layer or release layer, and wherein at least one of the adjacent adhesive or release layers are chosen to control the inter-laminar shear properties between at least one of the adjacent layers in the laminate sheet.

22. The laminate sheet of claim 21 further comprising at least one control layer to control the inter-laminar shear properties between at least one of the adjacent layers in the laminate sheet.

23. The laminate sheet of claim 22, wherein the control layer is an adhesive layer.

24. The laminate sheet of claim 22, wherein the control layer is a release layer.

25. The laminate of claim 24, wherein the release layer is selected from polyester film, polypropylene film, polyethylene film, urethane film, aluminum foil, steel foil, titanium foil, brass foil, copper foil, paper, or an applied liquid or dry powder coating.

26. A ballistic structure comprising the laminate sheet of claim 21.

27. A laminate sheet comprising at least one layer of unidirectionally-oriented fiber bundles bound together with an adhesive having a tensile modulus at 23° C. between about 7,000 psi and about 80,000 psi, wherein the adhesive penetrates the fiber bundles to form a matrix around at least one individual fiber in the fiber bundle and the adhesive comprises no more than about 30% by weight of the total laminate.

28. The laminate sheet of claim 27, comprising a first layer and a second layer, wherein the first layer comprises a first adhesive and the second layer comprises a second adhesive.

29. The laminate sheet of claim 28, wherein the first adhesive and the second adhesive do not bond well with each other, such that the bonding affinity between the first adhesive and the second adhesive is reduced by at least about 15% compared to the adhesion of either adhesive bonded to itself.

30. A laminate sheet of claim 27, comprising: a first layer, a second layer laminated to the first layer and oriented at an angle between 0 to 180 degrees relative to the first layer, a third layer laminated to the second layer and oriented at an angle between 0 and 180 degrees relative to the second layer, and a fourth layer laminated to third layer and oriented at an angle between 0 and 180 degrees relative to the third layer.

31. The laminate sheet of claim 27, further comprising at least one control layer for reducing inter-laminar shear strength disposed between adjacent layers.

32. The laminate sheet of claim 31, wherein the control layer comprises a release layer.

33. A ballistic structure comprising the laminate sheet of claim 27.
